(19) United States
(12) Patent Application Publication
(10) Pub. No.: US 2016/0204516 A1
(43) Pub. Date: Jul. 14, 2016

(54) Focusing Antenna

(71) Applicant: National Chiao Tung University, Hsinchu City (TW)

(72) Inventors: Shyh-Jong Chung, Hsinchu City (TW); Li-Han Kan, Hsinchu City (TW)

(73) Assignee: National Chiao Tung University, Hsinchu City (TW)

(21) Appl. No.: 14/982,354

(22) Filed: Dec. 29, 2015

(30) Foreign Application Priority Data
Jan. 8, 2015 (TW) 104100543

(51) Int. Cl. H01Q 15/24; H01Q 19/12; H01Q 1/12

(52) U.S. Cl. CPC H01Q 15/242; H01Q 1/12; H01Q 19/12

(57) ABSTRACT

A focusing antenna includes a feed-in antenna unit, a supportive reflecting unit and a main reflecting unit. The feed-in antenna unit radiates polarization signals polarizing in a first direction. The supportive reflecting unit includes a plurality of reflecting elements reflecting the polarization signals to generate a plurality of first reflected signals. The main reflecting unit compensates phases of the first reflected signals and rotates a direction of the first reflected signals to generate a plurality of second reflected signals having an electric field with polarization in a second direction perpendicular to the first direction.

### CROSS-REFERENCE TO RELATED APPLICATION

This application claims priority of Taiwanese Application No. 104100543, filed on Jan. 8, 2015.

### FIELD

The disclosure relates to an antenna, and more particularly to a focusing antenna operable to have a far-field pattern and a near-field pattern.

### BACKGROUND

FIG. 1 shows a conventional dish antenna which includes a feed-in antenna unit 5 and a curved dish 6. The feed-in antenna unit 5 is spaced apart from the dish 6, and is disposed at the focus of the dish 6. The dish 6 reflects radio signals emitted by the feed-in antenna unit 5 into a collimated beam. However, a radiation pattern of the conventional dish antenna may span a wide angle range with energy being wasted in the side lobes.

There is a conventional focusing antenna configured for improving energy utilization of the conventional dish ante a. The conventional focusing antenna includes a feed-in antenna unit, a reflecting board and a plurality of resonant elements. The reflecting board is spaced apart from the feed-in antenna unit by a distance equal to a focal length thereof, and reflects radio signals emitted by the feed-in antenna unit. Since a reflection path of each of the reflected radio signals may be different, phases respectively of the reflected radio signals may also be different. The resonant elements are disposed on the reflecting board for compensating the phases of the reflected radio signals. Thus, the reflected radio signals may have an identical phase and propagate in one direction. The disadvantage of the conventional focusing antenna is that the feed-in antenna unit has to be spaced apart from the reflecting board by the focal length of the reflecting board.

### SUMMARY

Therefore, an object of the disclosure is to provide a focusing antenna operable to have a far-field pattern and a near-field pattern.

According to one aspect of the disclosure, there is provided a focusing antenna that includes a feed-in antenna unit, a supportive reflecting unit and a main reflecting unit.

The feed-in antenna unit is used for radiating a plurality of first polarization signals having an electric field with polarization in a first direction.

The supportive reflecting unit is spaced apart from the feed-in antenna unit, and includes a focusing part and a plurality of reflecting elements. The focusing part has a mounting surface facing the feed-in antenna unit. The reflecting elements are disposed on the mounting surface of the focusing part, extend in the first direction in parallel with each other, and are spaced apart from each other in a second direction perpendicular to the first direction. The reflecting elements are configured to reflect the polarization signals to generate a plurality of first reflected signals.

The main reflecting unit is configured to compensate phases respectively of the first reflected signals and to rotate a direction of polarization of an electric field of the first reflected signals, so as to generate a plurality of second reflected signals that have an electric field with polarization in the second direction. The second reflected signals are focused by the focusing part to result in a radiation field pattern.

According to another aspect of this disclosure, there is provided a focusing antenna that includes a feed-in antenna unit and a supportive reflecting unit.

The feed-in antenna unit is for radiating a plurality of polarization signals having an electric field with polarization in a first direction.

The supportive reflecting unit is spaced apart from the feed-in antenna unit, and includes a focusing part and a plurality of reflecting elements. The focusing part has a mounting surface facing the feed-in antenna unit. The reflecting elements are disposed on the mounting surface of the focusing part, extend in a second direction perpendicular to the first direction, are parallel with each other, are spaced apart from each other in the first direction, and are configured to allow the polarization signals to pass therethrough. The focusing part is configured to focus the polarization signals passing through said reflecting elements to result in a radiation field pattern.

### BRIEF DESCRIPTION OF THE DRAWINGS

Other features and (advantages of the disclosure will become apparent in the following detailed description of the embodiments with reference to the accompanying drawings, of which:

FIG. 1 is a schematic view of a conventional dish antenna;

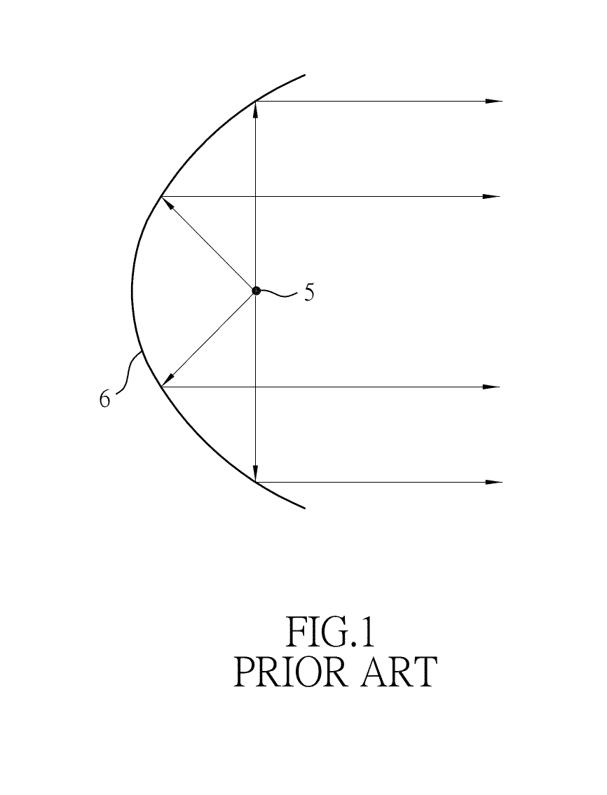

FIG. 2 is an exploded perspective view of a first embodiment of a focusing antenna according to the disclosure;

FIG. 3 is a side view of the first embodiment of the focusing antenna;

FIG. 4 is a radiation plot showing a far-field pattern of the first embodiment of the focusing antenna;

FIG. 5 is an exploded perspective view of a second embodiment of a focusing antenna according to the disclosure;

FIG. 6 is a side view of the second embodiment of the focusing antenna;

FIG. 7 is a radiation plot showing a near-field pattern of the second embodiment of the focusing antenna; and

FIG. 8 is an exploded perspective view of a third embodiment of a focusing antenna according to the disclosure.

### DETAILED DESCRIPTION

Before the disclosure is described in greater detail, it should be noted that like elements are denoted by the same reference numerals throughout the disclosure.

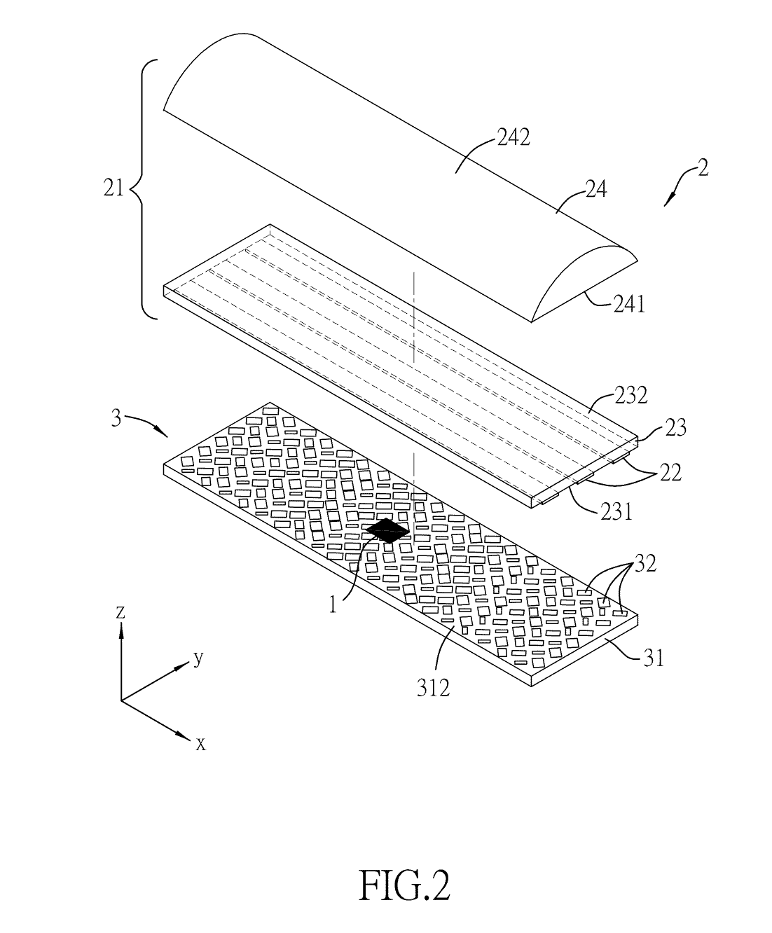

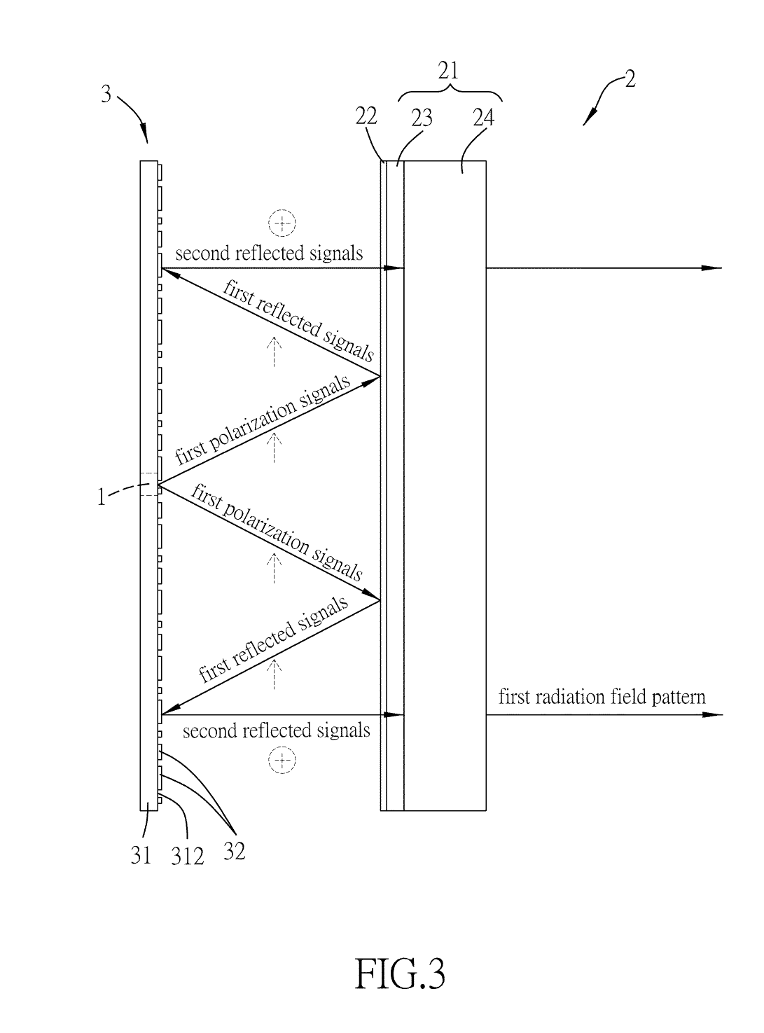

Referring to FIGS. 2 and 3, the first embodiment of the focusing antenna according to the disclosure includes a first feed-in antenna unit 1, a supportive reflecting unit 2 and a main reflecting unit 3.

The first antenna unit 1 radiates a plurality of first polarization signals. The first polarization signals have an electric field with polarization in the first direction. In particular, the first direction is, but not limited to, the direction (x) shown in FIG. 2.

The supportive reflecting unit 2 is spaced apart, from the first feed-in antenna unit 1, and includes a focusing part 21 and a plurality of reflecting elements 22. The focusing part. 21 is spaced apart from the first feed-in antenna unit 1, and has a mounting surface facing the first feed-in antenna unit 1 and having the reflecting elements 22 disposed thereon. In this embodiment, the focusing part 21 includes a supportive board 23 and a plano-convex lens 24. The supportive board 23 has a first surface 231 and a second surface 232. The first surface 231 faces the main reflecting unit 3, and serves as the mounting surface. The second surface 232 is opposite to the first surface 231. The plano-convex lens 24 is disposed on the supportive board 23, and extends in the first direction (x). The plano-convex lens 24 has a flat surface 241 that is attached to the second surface 232 of the supportive board 23, and a convex surface 242 that is opposite to the flat surface 241 and that constitutes a curved line in a cross-sectional view of the plano-convex lens 24 as viewed in the first direction (x). The reflecting elements 22 are disposed on the first surface 231 of the supportive board 23 (i.e., the mounting surface) and extend in the first direction (x) in parallel with each other. The reflecting elements 22 are spaced apart from each other in a second direction (y) perpendicular to the first direction (x). The distance between adjacent two of the reflecting elements 22 is less than one quarter of the wavelength of the first polarization signals. The reflecting elements 22 are configured to reflect the first polarization signals to generate the first reflected signals. The reflecting elements 22 are made of metal or any material that can reflect the first polarization signals.

In another configuration, the reflecting elements 22 can be disposed on the second surface 232 of the supportive board 23.

The main reflecting unit 3 is configured to compensate phases respectively of the first reflected signals from the supportive reflecting unit. 2, and to rotate a direction of polarization of an electric field of the first reflected signals, so as to generate a plurality of second reflected signals that have an electric field with polarization in the second direction (y).

In this embodiment, the main reflecting unit 3 includes a main board 31 and a plurality of resonant elements 32. The main board 31 is spaced apart from the supportive reflecting unit 2, and is provided with the first feed-in antenna unit 1. The main board. 31 has a flat surface 312 facing the supportive reflecting unit 2. The resonant elements 32 are spaced apart from each other and are disposed on the flat surface 312 of the main board 31. The resonant elements 32 of the main reflecting unit 3 are configured to reflect the first reflected signals, to compensate the phases of the first reflected signals, and to rotate the direction of polarization of the electric field of the first reflected signals into the second direction (y) so as to generate the second reflected signals. The second reflected signals may pass through the reflecting elements 22, and be focused by the plano-convex lens 24 of the focusing part 21 to result in a first radiation field pattern.

In detail by the above-mentioned configuration, the reflecting elements 22 prevent the first polarization signals from passing therethrough and reflect the first polarization signals into the first reflected signals toward the main reflecting unit 3 because the extension direction of the reflecting elements 22 (i.e., the first direction (x) identical to the polarization direction of the first polarization signals that is indicated by the dashed lines in FIG. 3. Since propagation paths respectively of the first reflected signals reflected by the supportive reflecting unit 2 toward the main reflecting unit 3 are different, the first reflected signals may disperse. Therefore, the resonant elements 32 are required to compensate the phases of the first reflected signals and to rotate the direction of polarization of the electric field of the first reflected signals by 90 degrees into the second direction (y). As a result, the second reflected signals may have the same phase and radiate in one direction, and the energy distribution of the second reflected signal is more concentrated in the first direction (x) (i.e., spans a smaller range in the first direction (x)).

The second reflected signals with the changed direction of polarization can propagate through the reflecting elements 22, and be focused by the plano-convex lens 24 to result in the first radiation field pattern. Since a distance from the convex surface 242 to the flat surface 241 of the planoconvex lens 24 gradually increases and then gradually decreases in the second direction (y), the energy distribution of the second reflected signals can be more concentrated in the second direction (y) (i.e., spans a smaller range in the second direction (y)).

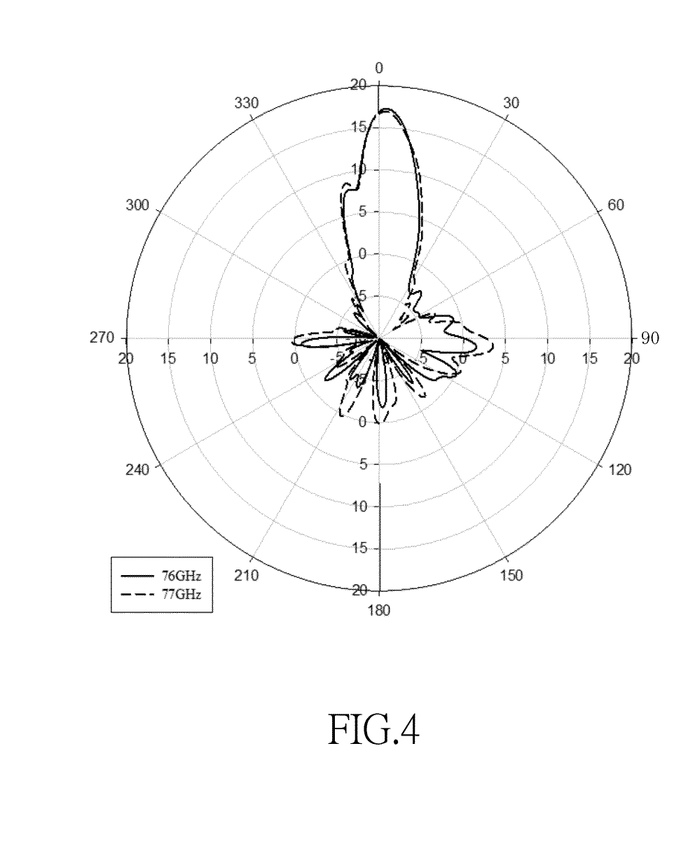

In other words, the energy distribution of the first radiation of field patter is more concentrated in the first direction (x) by virtue of the resonant elements 32 compensating the phases of the first reflected signals, and is more concentrated in the second direction (y) virtue of the plano-convex lens 24. Since the energy distribution of the first radiation field pattern is more concentrated in both the first and second directions (x) and (y), the focusing antenna of this embodiment can be operable to have a far field pattern having relatively greater gain and a relatively narrow beamwidth as shown in the first radiation field pattern of FIG. 4.

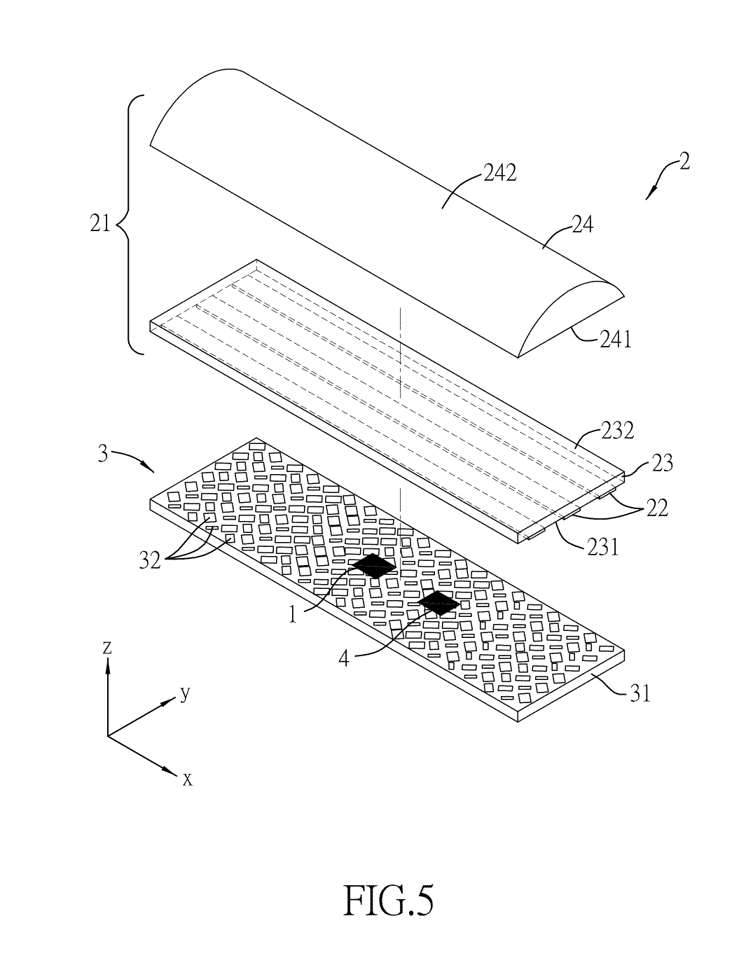

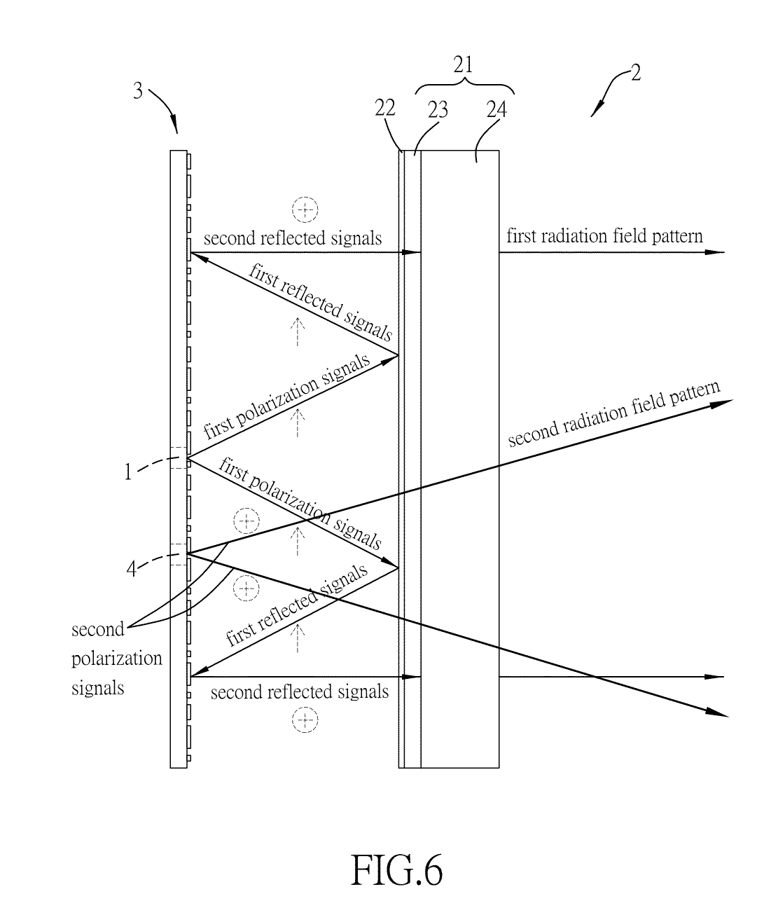

Referring to FIGS. 5 and 6, the second embodiment of a focusing antenna according to this disclosure is similar to the first embodiment. In the second embodiment, the focusing antenna further includes a second feed-in antenna unit 4. The second feed in antenna unit 4 is disposed on the main board 31 of the main reflecting unit 3, and is non-overlapping with respect to the first feed-in antenna unit 1. The second feed-in antenna unit 4 radiates a plurality of the second polarization signals that have an electric field with polarization in the second direction (y). The second polarization signals can pass through the reflecting elements 22, and be focused by the plano-convex lens 24 to result in a second radiation field pattern different from the first radiation field pattern.

The focusing antenna of the second embodiment is operable to have a far-field pattern and a near-field pattern. The far-field pattern of the focusing antenna (i.e., the first radiation field pattern) is the same as the first embodiment, and details thereof will be omitted herein for the sake of brevity.

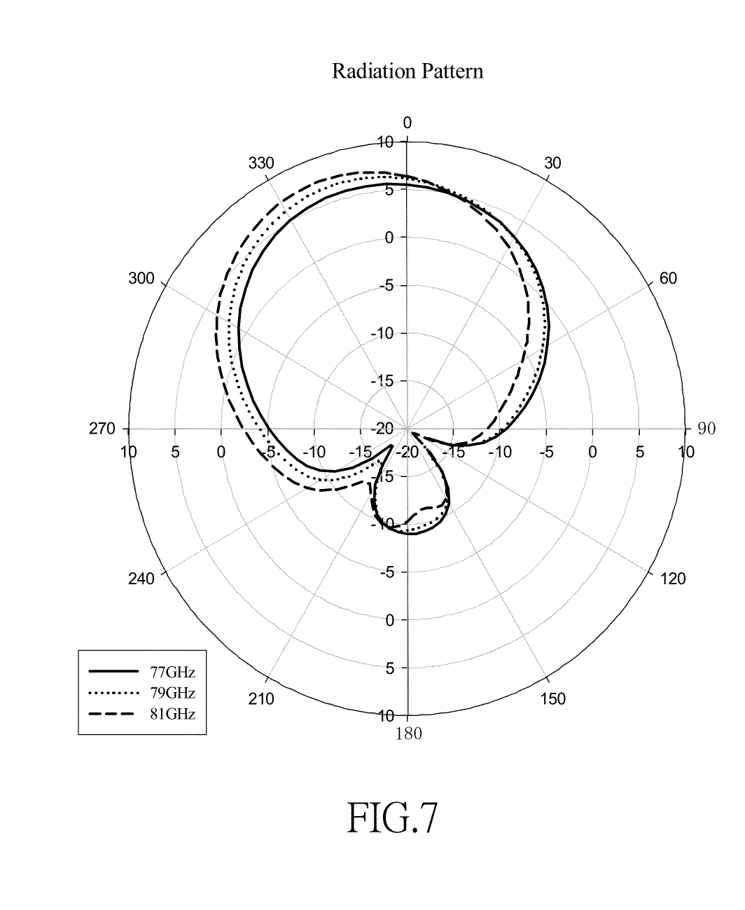

As for the near-field pattern (i.e., the second radiation field pattern), the second feed-in antenna unit 4 radiates the second polarization signals to the supportive reflecting unit 2, and the second polarization signals pass through the reflecting elements 22 since the direction of the electric field of the polarization of the second polarization signals (indicated by dashed lines in FIG. 6) is perpendicular to the extension direction of the reflecting elements (i.e., the first direction (x)). The second polarization signals are focused by the plano-convex lens 24 to result in the second radiation field pattern. By virtue of the convex surface 242 of the plano-convex lens 24, energy distribution of the second radiation field pattern is more concentrated in the second direction (y). Namely, the energy distribution of the second radiation field pattern is more concentrated only in the second direction (y), but not in the first direction (x). Since the energy distribution of the second radiation field pattern is more concentrated only in the second direction (y), the focusing antenna of this embodiment can be further operable to have the near-field pattern having relatively broad beamwidth as shown in the second radiation field pattern of FIG. 7.

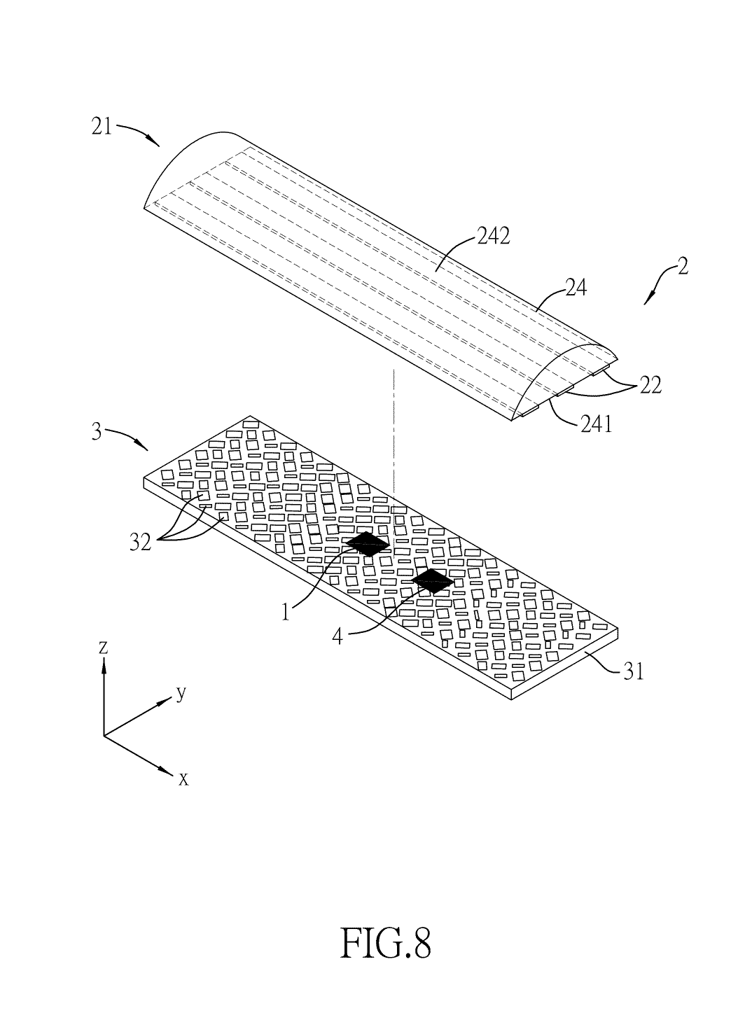

Referring to the FIG. 8, the third embodiment of the focusing antenna according to the disclosure is similar to the second embodiment. In the third embodiment, the supportive board 23 (see FIG. 5) is omitted and the focusing part 21 of the supportive reflecting unit 2 only includes the plano-convex lens 24. The flat surface 241 of the plano-convex lens 24 serves as the mounting surface. The reflecting elements 22 are disposed on the flat surface 241 of the plano-convex lens 24, and extend in the first direction (x). The operations of the focusing antenna of this embodiment are similar to those of the second embodiment, and thus details thereof are omitted herein for the sake of brevity.

In sum, the focusing antenna according to the disclosure has the following properties and advantages:

1. The energy distribution of the first radiation field pattern is more concentrated in the first direction (x) by virtue of the resonant elements 32, and is more concentrated in the second direction (y) by virtue of the plano-convex lens 24. The extension direction of the reflecting elements 22 (i.e., the first direction (x)) is perpendicular to the second direction (y), in which the distance from the convex surface 242 to the flat surface 241 of the plano-convex lens 24 gradually increases and then gradually decreases, and is parallel to the direction of the electric field of the first polarization signals radiated by the first feed-in antenna unit 1. Accordingly, the first polarization signals are reflected by the reflecting elements 22, are reflected by the main reflecting unit 3, and are focused by the focusing part 21, resulting in the first radiation field pattern having the energy distribution more concentrated in the first and second directions (x) and (y).

2. As for the near-field pattern (i.e., the second radiation field pattern), the extension direction of the reflecting elements 22 is perpendicular to the direction of the electric field of the polarization signals radiated by the second feed-in antenna unit 4. The second polarization signals can pass through the supportive reflecting unit 2, and be focused by the plano-convex lens 24, resulting in tire second radiation field pattern having the energy distribution more concentrated in the second direction (y).

3. The focusing antenna is operable to have the far-field pattern having the energy distribution more concentrated in both the first direction (x) and second direction (y) and having relatively greater gain and a relatively narrow beamwidth. The focusing antenna is further operable to have the near-field pattern having the energy distribution more concentrated only in the second direction (y) and having a relatively broad beamwidth. Therefore, the focusing antenna according to this disclosure can radiate with a radiation pattern having the energy distribution more concentrated in desired direction (s), can prevent the energy from being wasted in other unnecessary direction(s), and can properly raise the gain in both the far-field pattern and the near-field pattern.

4. The focusing antenna is configured to enhance the gain and concentrate the energy distribution by a two-stage reflection, and the first feed-in antenna unit 1, the second feed-in antenna unit 4 and the resonant elements 32 are all disposed on the main board 31 of the main reflecting unit 3, so that the first feed-in antenna unit 1 and/or the second feed-in antenna unit 4 are not required to be spaced apart from the main reflecting unit 3 by a specific distance. Hence, the height of the focusing antenna according to this disclosure in a direction (z) is significantly decreased.

While the disclosure has been described in connection with what are considered the exemplary embodiments it is understood that this disclosure is not limited to the disclosed embodiments but is intended to cover various arrangements included within the spirit and scope of the broadest interpretation so as to encompass all such modifications and equivalent arrangements.

What is claimed is:

1. A focusing antenna comprising:
a first feed-in antenna unit for radiating a plurality of first polarization signals having an electric field with polarization in a first direction;
a supportive reflecting unit spaced apart from said first feed-in antenna unit, and including
a focusing part that has a mounting surface facing said first feed-in antenna unit, and
a plurality of reflecting elements that are disposed on said mounting surface of said focusing part, that extend in the first direction in parallel with each other, that are spaced apart from each other in a second direction perpendicular to the first direction, and that are configured to reflect the first polarization signals to generate a plurality of first reflected signals; and
a main reflecting unit configured to compensate phases respectively of the first reflected signals and to rotate a direction of polarization of an electric field of the first reflected signals, so as to generate a plurality of second reflected signals that have an electric field with polarization in the second direction, and that are focused by said focusing part to result in a first radiation field pattern.

2. The focusing antenna as claimed in claim 1, wherein said focusing part includes a plano-convex lens extending in the first direction and having a flat surface that serves as said mounting surface where said reflecting elements are disposed, and a convex surface that is opposite to said flat surface and that constitutes a curved line in a cross-sectional view of said plano-convex lens as viewed in the first direction.

3. The focusing antenna as claimed in claim 1, wherein said focusing part includes:
a supportive board having a first surface that faces said main reflecting unit and that serves as said mounting surface having said reflecting elements disposed thereon, and a second surface that is opposite to said first surface; and
a plano-convex lens extending in the first direction, disposed on said supportive board, and having a flat surface that is attached to said second surface, and a convex surface that is opposite to said flat surface and that constitutes a curved line in a cross-sectional view of said planoconvex lens as viewed in the first direction.

4. The focusing antenna as claimed in claim 1, wherein said main reflecting unit includes:
a main board that is spaced apart from said supportive reflecting unit, that is provided with said first feed-in antenna unit, and that has a flat surface facing said supportive reflecting unit; and
a plurality of resonant elements that are spaced apart from each other, that are disposed on said flat surface of said main board, and that are configured to reflect the first reflected signals, to compensate the phases of the first reflected signals, and to rotate the direction of polarization of electric field of the first reflected signals into the second direction so as to generate the second reflected signals.

5. The focusing antenna as claimed in claim 4, further comprising a second feed-in antenna unit disposed on said main board, spaced apart from said first feed-in antenna, and configured to radiate a plurality of second polarization signals that have an electric field with polarization in the second direction and that are focused by said focusing part to result in a second radiation field pattern different from the first radiation field pattern.

6. The focusing antenna as claimed in claim 5, wherein the first radiation field pattern is a far-field pattern and the second radiation field pattern is a near-field pattern.

7. The focusing antenna as claimed in claim 5, wherein said focusing part includes:
a supportive board having a first surface that faces said main reflecting unit and that serves as said mounting surface having said reflecting elements disposed thereon, and a second surface that is opposite to said first surface; and
a convex lens extending in the first direction, disposed on said supportive board, and having a flat surface that is attached to said second surface of said supportive board, and a convex surface that is opposite to said flat surface and that constitutes a curved line in a cross-sectional view of said plano-convex lens as viewed in the first direction;
wherein said reflecting elements are configured to allow the second polarization signals to pass therethrough, and said plano-convex lens is configured to focus the second polarization signals passing through said reflecting elements.

8. A focusing antenna comprising:
a first feed-in antenna unit for radiating a plurality of first polarization signals having an electric field with polarization in a first direction; and
a supportive reflecting unit spaced apart from said first feed-in antenna unit, and including
a focusing part that has a mounting surface facing said first feed-in antenna unit, and
a plurality of reflecting elements that are disposed on said mounting surface of said focusing part, that extend in a second direction perpendicular to the first direction, that are parallel with each other, that are spaced apart from each other in the first direction, and that are configured to allow the first polarization signals to pass therethrough, said focusing part being configured to focus the first polarization signals passing through said reflecting elements to result in a first radiation field pattern.

9. The focusing antenna as claimed in claim 8, wherein said focusing part includes a plano-convex lens extending in the second direction and having a flat surface that serves as said mounting surface where said reflecting elements are disposed, and a convex surface that is opposite to said fl at surface and that constitutes a curved line in a cross-sectional view of said plano-convex lens as viewed in the second direction.

10. The focusing antenna as claimed in claim 8, wherein said focusing part includes:
a supportive board having a first surface that faces said main reflecting unit and that serves as said mounting surface having said reflecting elements disposed thereon, and a second surface that is opposite to said first surface; and
a plano-convex lens extending in the second direction, disposed on said supportive board, and having a flat surface that is attached to said second surface, and a convex surface that is opposite to said flat surface and that constitutes a curved line in a cross-sectional view of said plano-convex lens as viewed in the second direction.

11. The focusing antenna as claimed in claim 8, further comprising a second feed-in antenna unit that is spaced apart from said supportive reflecting unit, and that is configured to radiate a plurality of second polarization signals that have an electric field with polarization in the second direction,
wherein said reflecting elements are configured to reflect the second polarization signals to generate a plurality of first reflected signals.

12. The focusing antenna as claimed in claim 11, further comprising a main reflecting unit that includes:
a main board that is spaced apart from said supportive reflecting unit, that is provided with said first and second feed-in antenna units, and that has a flat surface facing said supportive reflecting unit; and
a plurality of resonant elements that are spaced apart from each other, that are disposed on said flat surface of said main board, and that are configured to reflect the first reflected signals, to compensate phases respectively of the first reflected signals, and to rotate a direction of polarization of an electric field of the first reflected signals into the second direction so as to generate a plurality of second reflected signals having an electric field with polarization in the first direction.

13. The focusing antenna as claimed in claim 12, wherein said focusing part includes:
a supportive board having a first surface that faces said main reflecting unit and that serves as said mounting surface having said reflecting elements disposed thereon, and a second surface that is opposite to said first surface; and
a plano-convex lens extending in the second direction, disposed on said supportive board, and having a flat surface that is attached to said second surface, and a convex surface that is opposite to said flat surface and that constitutes a curved line in a cross-sectional view of said plano-convex lens as viewed in the second direction;
wherein said reflecting elements are configured to allow the second reflected signals to pass therethrough, and said plano-convex lens is configured to focus the second reflected signals passing through said reflecting elements to result in a second radiation field pattern different from the first radiation field pattern.

14. The focusing antenna as claimed in claim 13, wherein the first radiation field pattern is a near-field pattern, and the second radiation field pattern is a far-field pattern.
